(19) United States
(12) Patent Application Publication
(10) Pub. No.: US 2010/0115012 A1
(43) Pub. Date: May 6, 2010

(54) Methods for Defining Content for Display on a Digital Display Device at a Point of Purchase

(75) Inventors: Michael Yip, Los Altos, CA (US); Jiping Zhu, San Jose, CA (US); Michael Mo, Saratoga, CA (US)

Correspondence Address: Venture Pacific Law, PC, 5201 Great America Parkway, Suite 270, Santa Clara, CA, 95054, US

(73) Assignee: AMLOGIC, INC., Santa Clara, CA (US)

(21) Appl. No.: 12/259,265

(22) Filed: Oct. 27, 2008

(51) Int. Cl. G06F 17/30

(52) U.S. Cl. 707/899; 707/E17.031

(57) ABSTRACT

The present invention relates to methods for defining content at the point of purchase of a digital display device (“DDD”), such as a digital picture frame, and for managing content for the DDD. These methods may include the following steps of: defining content for a DDD by a first DDD content provider at a point of purchase; associating a frame content ID with the defined content; and programming the DDD of the DDD with the frame content ID prior to shipping of the DDD.

### FIELD OF THE INVENTION

This invention relates to methods for defining content for display on a digital display device (“DDD”), such as a digital picture frame (“DPF”), and, in particular, to methods for defining content and for managing content for display on a DDD.

### BACKGROUND

DDDs such as DPFs provide for the display or for the playback of one or more contents of a DDD, where the one or more contents may be a collection of photos, images, videos, music, recordings, or other items that can be displayed or played back on a DDD. Content may be herein defined to mean one or more contents. The advancement in the mass production of LCD's resulted in the lowering of the cost of the LCD's and therefore the DDDs. As DDDs become more and more popular, the particular problems associated with DDDs are becoming apparent and require customized solutions. There are several factors to consider with respect to DDDs, for example image quality, ease of setup, ease of use, and image presentation.

Initially when DDDs were first marketed, the content of a DDD was updated by physically connecting the DDD to a storage device through a universal serial bus (“USB”) interface or other interface systems. The content was then downloaded from the storage device to the DDD. Today, DDDs can be updated through other means as well, such as through the internet FIG. 1 illustrates a prior art method for updating a DDD by using the internet The DDD 100 can update content through the internet 116 by using a broadband connection 102 and/or a phone connection 104 to connect to a server, and then download content from the server.

Generally, the DDD will log in to a server that stores the associated account for the DDD 100. If the account has new content, then the DDD can download that content through the internet Content can be added to the account through a variety of methods, including uploading pictures from a computer 112 to the server 106 or even uploading content to the server from a cell phone 108, a PDA 110, a camera 114, or other storage devices.

A DDD content provider may be herein defined as a person who adds content to the account or can manage content for a DDD. A DDD viewer may be herein defined as the person who views and uses a DDD. For instance, if a grandson buys his grandmother a DDD and defines content for the DDD, then the grandson is the DDD content provider and the grandmother is the DDD viewer.

There can also be one or more DDD content providers and one or more DDD viewers. In addition, the one or more DDD content providers may be the same person(s) as the one or more DDD viewers. For instance, the grandson may buy a DDD for himself, where the content of that DDD is defined by him and by his grandmother. In this case, the grandson is a DDD content provider and a DDD viewer for the DDD. Since the grandmother is also defining content for that DDD, she is a DDD content provider. In another instance, the grandson may buy a DDD for himself and his wife to view, where the content for that DDD is defined by him, by his wife, and by his grandmother. Here, the DDD viewers are the grandson and the grandson's wife. The DDD content providers are the grandson, the grandson's wife, and the grandmother. The permutations for one or more DDD content providers and one or more DDD viewers are limitless.

As technological advancement in DDDs progresses, the complexity in operating DDDs also increases as well. A DDD viewer must accordingly be sophisticated to operate these new technologies. FIG. 2 illustrates how a DDD viewer may update a DDD by connecting to a server through the internet The DDD viewer 200 logs in to his/her DDD account through the internet by way of a computer 202, or by way of other means, to manage the content of the DDD 204. This poses a particular problem for those who do not have access to the internet and those who are not technologically savvy.

Therefore, it is desirable to provide methods where the content of a DDD may be defined before being shipped to a DDD viewer, and where managing the content of the DDD may be performed with or without the aid of the DDD viewer.

### SUMMARY OF THE INVENTION

An object of this invention is to provide methods for defining content at the point of purchase of a DDD.

Another object of this invention is to provide methods for managing content.

Another object of this invention is to provide methods for selecting a display setting for a DDD.

The present invention relates to methods for defining content at the point of purchase of a DDD, such as a digital picture frame, and for managing content for the DDD. These methods may include the following steps of: defining content for a DDD by a first DDD content provider at a point of purchase; associating a frame content ID with the defined content; and programming the DDD of the DDD with the frame content ID prior to shipping of the DDD.

An advantage of this invention is that a DDD may be shipped to a DDD viewer prepackaged with the defined content downloaded to the DDD.

Another advantage of this invention is that a DDD content provider may update content of a DDD without the DDD viewer having to undertake any action.

Yet another advantage of this invention is that a display setting for defined content may be defined by one or more DDD viewers or defined by the DDD.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a prior art method for updating content of a DDD through the internet.

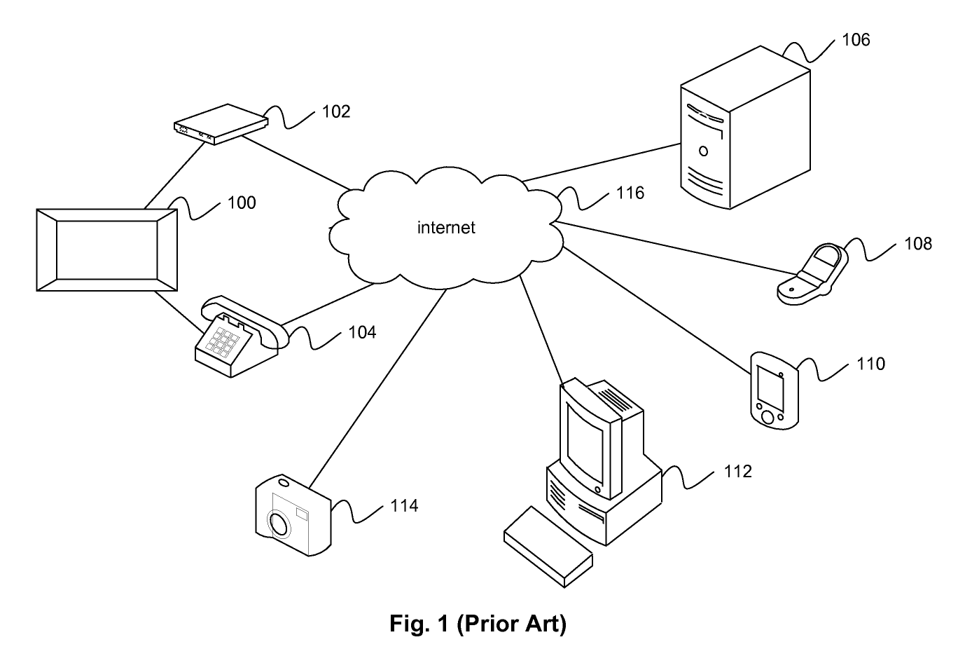

FIG. 2 illustrates a DDD viewer managing the content of his/her DDD.

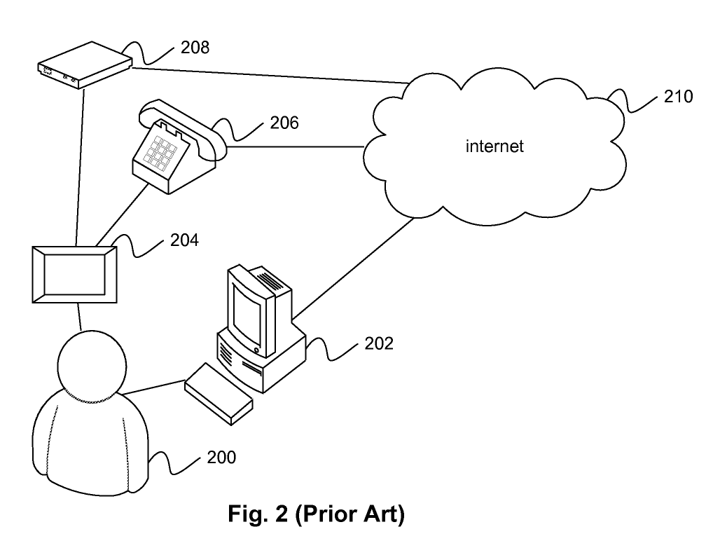

FIG. 3 illustrates a method of this invention.

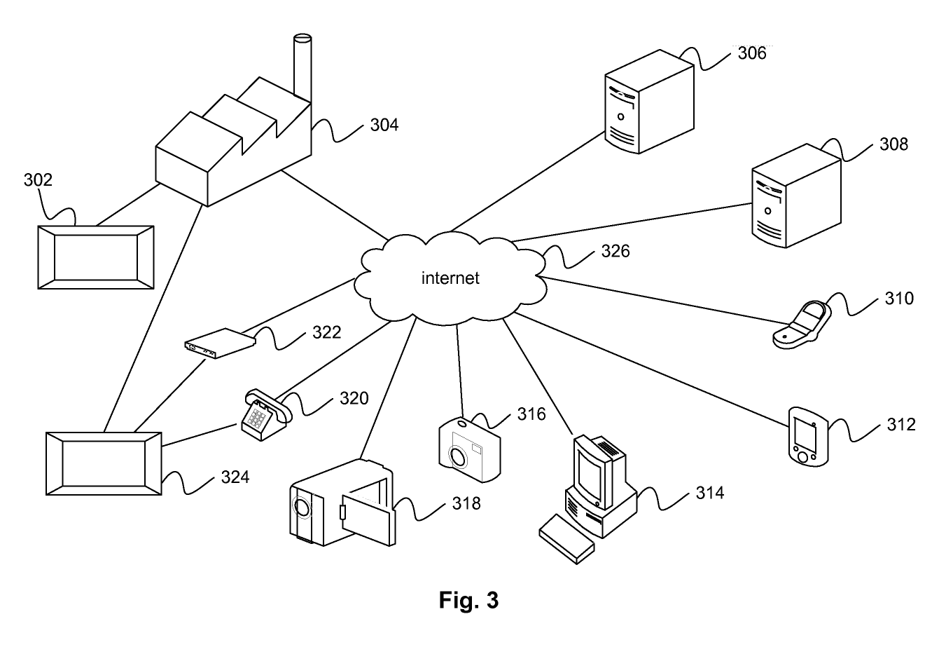

FIG. 4 illustrates a result of this invention, where a DDD viewer is sent a DDD with defined content already downloaded to the DDD prior to shipping of the DDD.

FIG. 5a illustrates a process flow of a method of this invention for defining content for a DDD at the point of purchase of the DDD.

FIG. 5b illustrates a process flow of a method of this invention for setting up a user account.

FIG. 5c illustrates a process flow of a method of this invention for selecting a DDD.

FIG. 5d illustrates a process flow of a method of this invention for selecting content for the DDD.

FIG. 5e illustrates a process flow of a method of this invention for generating a frame content ID and creating an order for the DDD.

FIG. 5f illustrates a process flow of a method of this invention for programming the DDD and shipping the DDD.

FIG. 6 illustrates a process flow of a method of this invention for managing a user account.

FIG. 7a illustrates a process flow of a method of this invention for downloading content for a DDD from a storage device.

FIG. 7b illustrates a process flow of a method of this invention for downloading content for a DDD by connecting to a DDD server.

FIG. 7c illustrates a process flow of a method of this invention for selecting a display setting for the content of one or more frame content IDs.

### DETAILED DESCRIPTION OF THE PREFERRED EMBODIMENTS

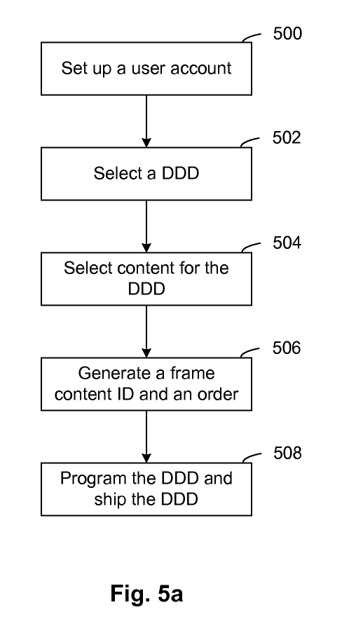

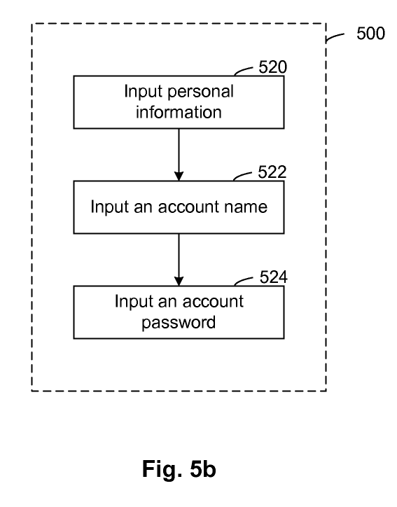

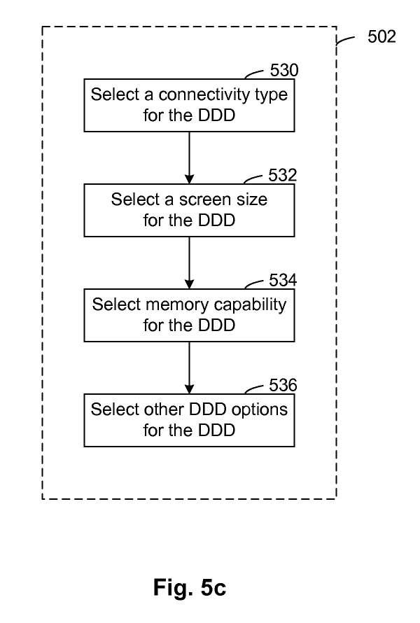

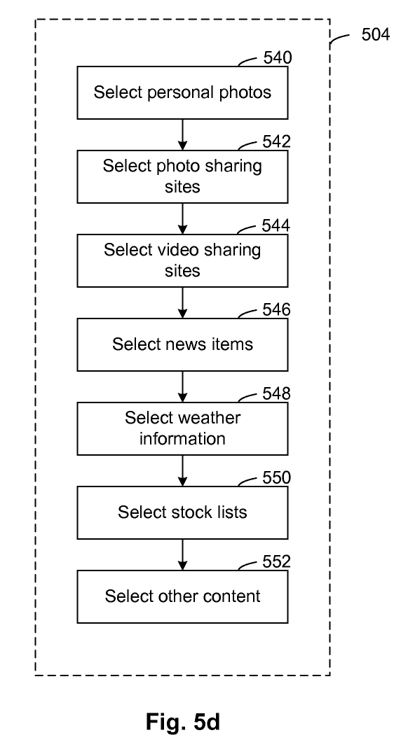

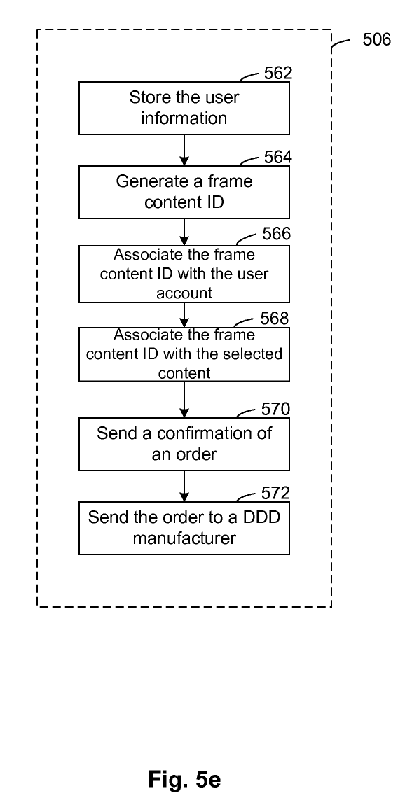

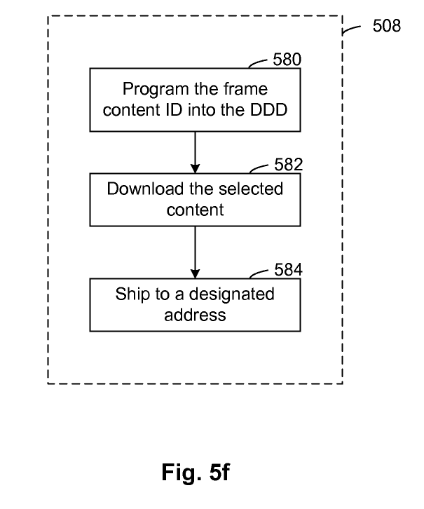

FIG. 5a illustrates a process flow of a presently preferred method of this invention for defining content at a point of purchase. A point of purchase can mean a retail shop, a flea market, a computer connecting to an online retailer through the internet, or other locations where a DDD can be purchased. For instance, if a grandson buys a DDD for his grandmother at a department store, then the point of purchase is at the department store. If the grandson instead buys a DDD for his grandmother through an online retailer such as Amazon or EBay, then the point of purchase can be at the website where the grandson is accessing the online retailer to purchase the DDD. A first DDD content provider may be herein defined to be the person who defines content at the point of purchase for a DDD.

At the point of purchase, the first DDD content provider of a DDD can set up a user account 500 for the purpose of defining content for a DDD and managing content for the DDD. The first DDD content provider may then select the options for a DDD 502. After a DDD has been selected, the first DDD content provider can select content 504 to be displayed on the selected DDD. A frame content ID is then generated 506, and associated to the selected content. Next, an order can be created containing information about the selected DDD, the generated frame content ID, the selected content, and other related information. The order is then sent to a DDD manufacturer. The DDD manufacturer uses the information from the order to program the selected DDD with the generated frame content ID. After programming, the DDD is shipped to a designated address 508, where the point of purchase and the designated address are at different locations.

FIG. 5b illustrates the process flow of a method of this invention for setting up a user account. In setting up the user account 500, the first DDD content provider may input personal information 520, including a name, a mailing address, an email address, a home phone number, a work phone number, a cellular phone number, credit card information, and other personal information.

The first DDD content provider can input a user account name 522 for the user account. A user account name may be defined as a unique sequence of characters the first DDD content provider chooses to represent the user account. The user account name may not be in use by another user account since associating one user account name to multiple user accounts may lead to confusion as to which user account to access.

Next, the first DDD content provider inputs a user account password 524 for the user account. To ensure a minimum level of security to prevent unauthorized access to the user account, the user account password may have to meet specified minimum requirements. For instance, the user account password may be required to contain both alphabetic characters and numeric characters, be of a certain character length, contain a combination of upper case letters and lower case letters, or have other requirements. After the password has been entered, this completes the process for setting up the user account. However, other embodiments of this invention may include additional steps.

FIG. 5c illustrates the process flow of a method of this invention for selecting a DDD. DDDs come in a variety of options that the first DDD content provider may select from, including various connectivity types 530, various screen sizes 532, various memory capabilities 534, and other DDD options 536.

The following terms are herein defined in association with selecting a DDD 502 to aid in the understanding of this process flow. The connectivity type may refer to the capability of a DDD to update content through a variety of technologies, such as through the internet via a wired broadband connection, a wireless broadband connection, a telephone connection, a satellite connection, or a cellular phone connection, a multimedia card reader, a universal serial bus (“USB”) connection, and other types of connections.

The screen size may be defined to include the vertical, horizontal, or diagonal measurement of the display window of the DDD screen. The display window may be defined as the viewable screen of the DDD.

The memory capability of a DDD may refer to the amount of internal memory of the DDD. For instance, a DDD may contain a preinstalled amount of internal memory for storing images or videos for display. However, memory capability is not limited to internal memory since a DDD may augment its memory capacity by inserting and/or connecting to a storage device such as a secured digital card, a memory stick, a compact flash card, a microdrive, a hard drive, and other storage devices.

A DDD may include other options not stated above. For instance, other options that the first DDD content provider may select include the ability to play video content such as movie picture experts group (“MPEG”) files, the ability to play music content such as MPEG-1 audio layer 3 (“MP3”), files, software features, different types of DDD faceplates, and other options.

After a DDD has been selected, then the first DDD content provider can select content to be displayed on the selected DDD. FIG. 5d illustrates a process flow of a method of this invention for selecting content for the DDD. The first DDD content provider may select various content including personal photos 540, photos from photo sharing sites 542, video sharing sites 544, news items 546, weather information 548, stock lists 550, and other content 552.

The process of selecting personal photos 540 can include selecting the first DDD content provider's photos and uploading the selected first DDD content provider's photos to the user account. The photos may be uploaded from any media device, such as a storage device, a capture device, or any other media.

In selecting content from one or more photo sharing sites 542, the first DDD content provider can input the names and/or locations of the one or more photo sharing sites, such as the domain names or the Internet Protocol (“IP”) addresses of the one or more photo sharing sites, the associated user name and user password for each of the one or more photo sharing sites, and a selection of one or more photos from each of the one or more photo sharing sites to add to the selected content. Examples of photo sharing sites are Flickr, Mac Web Gallery, Atpic, Kodak Easy Share Gallery, Photobucket, Picasa, Snapfish, and others photo sharing websites. The first DDD content provider may also be asked to input additional information to access special features of the photo sharing sites. For instance, some photo sharing sites provide the functionality to display all photos containing a specified person by simply inputting the name of a person to display. This method of this invention may require additional information to access this special feature, such as the personal name or user name of the specified person.

The first DDD content provider may select one or more video sharing sites 544 to add as content by inputting the names and/or locations of the one or more video sharing sites, such as the domain names or the IP addresses of the one or more video sharing sites, the associated user login and user password, if any, for the video sharing site, and one or more videos to add to the selected content. Similarly to accessing features of a photo sharing site, the first DDD content provider may input additional information to access features provided by the video sharing site. Examples of video sharing sites are YouTube, Veoh, and Crunchyroll.

In order to select the news items 546, the first DDD content provider can input the locations, such as the domain names or IP addresses of the news items. The location may be for a specific news article or contain multiple articles for the DDD viewer to choose from. For instance, if the first DDD content provider wants the DDD viewer to have access to one or more specific articles, then the first DDD content provider may identify the domain name or the IP address for each of those articles. Additionally, the location may be a domain name or an IP address containing multiple articles. For instance, the domain name may be www.cnn.com, where CNN may have several links to articles that the DDD viewer may choose from. The DDD viewer may then have the option to pick out which articles to read by either inputting that decision to the DDD or possibly defining which articles to display on the DDD.

The first DDD content provider can select weather information as content for the DDD 548 by inputting one or more geographic locations for which weather information would like to be displayed. The first DDD content provider can input one or more geographic locations by zip code, mailing address, city and state, longitude and latitude, by a pointer to a map location, or any other means to identify geographic location.

In order to select stock lists 550, the first DDD content provider can select one or more stock quotes to display by inputting the associated company name, company stock symbol, or other identifier of the company for each of the selected stock quotes. In addition to displaying individual stock quotes, the first DDD content provider can select one or more stock market indexes as content such as the American Dow Jones Industrial Average and S&P 500 Index, the British FTSE 100, the French CAC 40, the German DAX, the Japanese Nikkei 225, the Indian Sensex, and the Hong Kong Hang Seng Index.

The first DDD content provider can select other content 552, such as music, videos, video games, flash games, and any other content which may be from the internet or other sources.

FIG. 5e illustrates the process flow of a method of this invention for generating a frame content ID and creating an order for the DDD. Once the content has been selected, the first DDD content provider's account information, such as the first DDD content provider's personal information, the user account name, the user account password, and the selected content, is stored 562 in the DDD server. A frame content ID is then generated 564, and associated with the user account 566. The frame content ID may also be associated with the first DDD content provider selected content 568, and finally stored on the user's account. In the preferred embodiments of this invention, the frame content ID is a unique number assigned to be associated with the selected content. In other embodiments of this invention, the frame content ID may be anything used to identify the selected content such as an alphanumeric sequence, a sequence containing symbols, or any other identifier.

The first DDD content provider can input a nickname or alias for the frame content ID, such that the first DDD content provider may associate the content of the frame content ID with that nickname or alias, rather than a randomly assigned frame content ID number. This makes it especially easier on the first DDD content provider to remember which frame content ID is associated with which DDD. For instance, the first DDD content provider may have multiple frame content IDs associated with his/her user account, so instead of trying to remember what frame content ID number corresponds to which selected content, the first DDD content provider may assign a descriptive name for one or more of the frame content IDs. For instance, the frame content ID may be assigned the nickname “grandma” to refer to a frame content ID that contains content for the first DDD content provider's grandmother.

After the frame content ID has been associated with the selected content 568, a confirmation order is generated and sent to the first DDD content provider 570. The order may contain detailed information about the first DDD content provider's selections, including a specification of the selected DDD, the type, the location, and other information of the selected content, and the character sequence of the associated frame content ID, and other information. The order is also sent to the DDD manufacturer 572 for use in programming the DDD with the associated frame content ID.

FIG. 5f illustrates the process flow of a method of this invention for programming the DDD prior to shipping of the DDD and shipping the DDD. The manufacturer uses the information from the order to program the selected DDD 580 with the frame content ID. If the DDD connectivity options do not allow for a broadband internet access update or other updating means for the content of the frame content ID, then the manufacturer may download the selected content directly to the DDD before shipping the DDD.

If the DDD does have a broadband connection then the DDD manufacturer may download none of, a part of, or all of the selected content. The decision to download may be based on the memory capability of the DDD, the data size of the content, the first DDD content provider's defined options, the selected content of the DDD, the manufacturer's broadband internet bandwidth, and other factors which may be related.

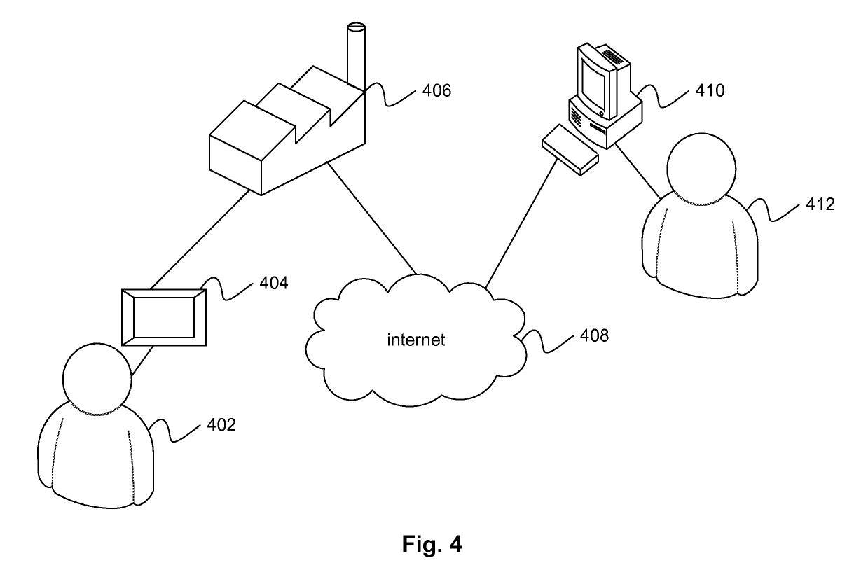

After the content is downloaded, the programmed DDD is shipped to a designated address. The designated address is inputted by the first DDD content provider, but may or may not be the first DDD content provider's address. For instance, the first DDD content provider may be buying the DDD for their own use, in which case they would probably ship the DDD to their own address, or alternatively, the first DDD content provider could be buying the DDD for their grandmother who may live at a different address. FIG. 4 illustrates the case where the first DDD content provider 412 is not the same person as the DDD viewer 402. In FIG. 4, the first DDD content provider 412 defines the content for the DDD by connecting to the user account through the internet and selecting the content for the DDD. Once the setup process is complete, an order is generated and sent to the DDD manufacturer 406, where the DDD 404 is programmed and shipped to the DDD viewer 402.

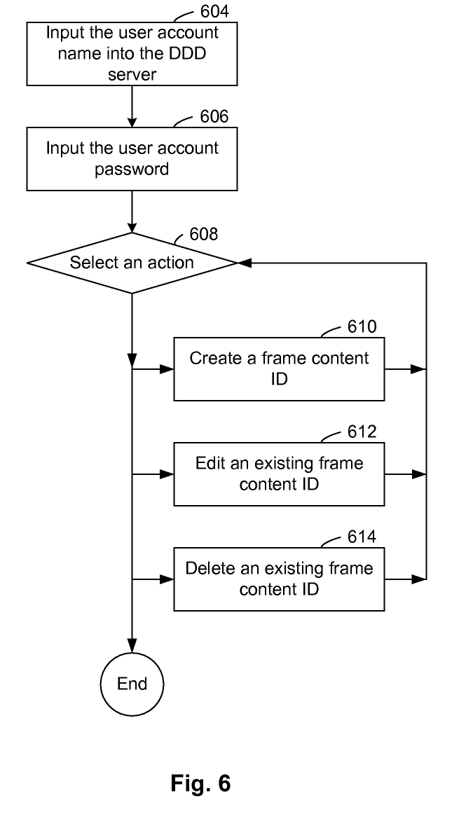

FIG. 6 illustrates the process flow of a method of this invention for managing a user account. In order to access the user account, the DDD content provider must first log in to the DDD server by inputting the user account name 604 and inputting the associated account password 606. Once the login information has been verified, the DDD content provider may select an action 608 to perform.

The DDD content provider may create a new frame content ID 610 by inputting one or more locations of content or by designating existing content to add to the created frame content ID. For instance, if the DDD content provider has an existing frame content ID, the DDD content provider may select one or more contents of the existing frame content ID to add to the newly created frame content ID. This provides the DDD content provider the functionality to easily share content by quickly setting up multiple DDDs with similar content. The DDD content provider may also add new content by specifying the location of the new content and the associated log in information, if any, for the new content. Once the content has been selected, the DDD server generates a frame content ID, associates the selected content with the generated frame content ID, and finally stores the frame content ID and the selected content information in the DDD server.

The DDD content provider may also edit an existing frame content ID 612. If the DDD content provider does not have at least one frame content ID, then the DDD content provider does not have the option to edit an existing frame content ID since none exists. If there is only one frame content ID, that frame content ID will be selected for editing. If the DDD content provider has more than one, then the DDD content provider must select one frame content ID to edit.

Once the DDD content provider has selected a frame content ID to edit, the DDD content provider has the option to select new content to add to the frame content ID, delete content from the frame content ID, or change the content of the frame content ID. For instance, if the selected content is from a Flickr account, an online photo sharing site, the DDD content provider may want to keep the login information for Flickr, but may want to change the content to different images within the Flickr account. Thus, the DDD content provider is able to designate images or other content for a location containing selected content without having to input the location of the content provider and the associated login information for that content provider.

Also, editing the frame content ID 612 may include changing the associated DDD for the frame content ID, deleting the reference to the associated DDD, adding other DDDs to associate with the frame content ID. A frame content ID may be associated to a DDD by storing a unique identifier of the DDD, including, but not limited to, the DDD's serial number, the DDD's IP address, or other unique identifiers of the DDD.

The DDD content provider may delete a frame content ID. The frame content ID is deleted from the user's account, thus all information relating to selected content may be lost by deleting the frame content ID. Additionally, when a frame content ID is created, it can be added to a database in which the unique identifier of the DDD is the main entry. The frame content IDs associated with that DDD are stored on this database of DDD unique identifiers. When the DDD logs in to the DDD server, the DDD server searches the database of DDD unique identifiers for the DDD unique identifier, and retrieves the frame content IDs associated with that DDD unique identifier.

If a DDD uses a frame content ID to log in to the DDD server, where that frame content ID has been deleted, an unsuccessful log in message will be returned to the DDD viewer stating that the frame content ID no longer exists. The DDD may delete that frame content ID from its memory and retry logging in. The DDD can either try a different frame content ID stored on the DDD or the DDD unique identifier. In the preferred embodiments, the DDD will log in to the DDD server using the unique identifier to avoid unsuccessful log in. Once the DDD content provider is done managing the user account, the DDD content provider may select end to finish their session.

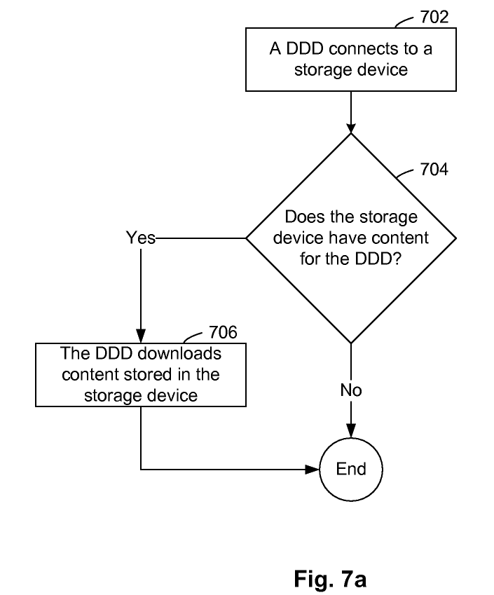

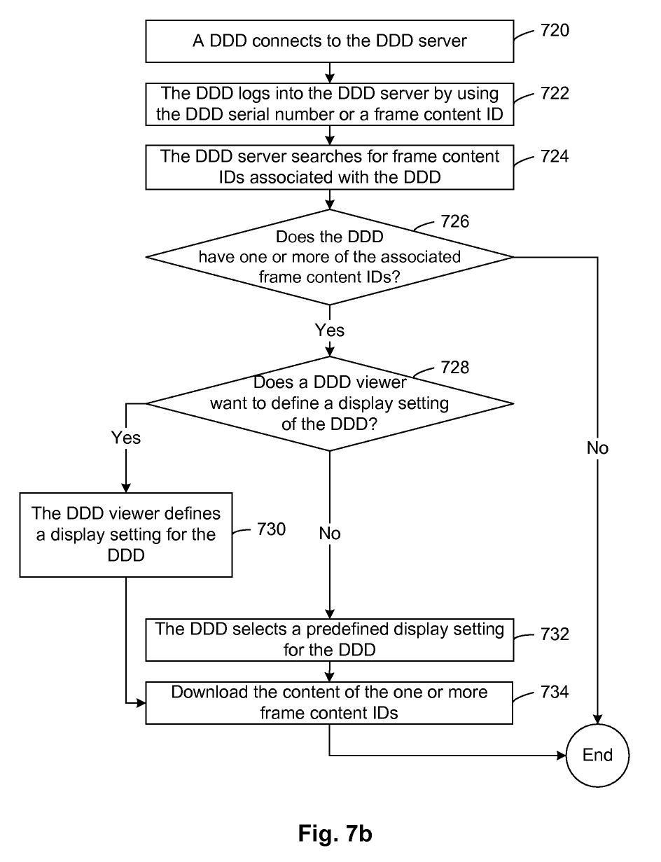

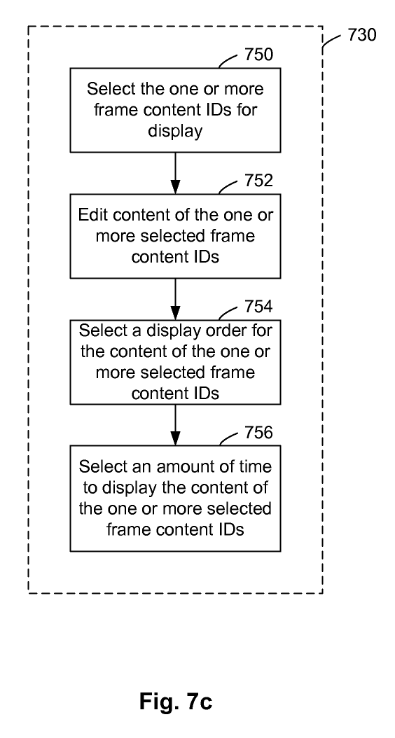

FIG. 7a illustrates the process flow of a method of this invention for downloading content to a DDD from a storage device. The DDD can connect to the storage device 702 either by directly connecting the storage device to the DDD or through a wireless connection, such as a Bluetooth connection, a wireless local area network, or other connection means. After the storage device is connected, the DDD searches the storage device for content 704. The DDD may search by checking whether the one or more frame content IDs of the DDD match the one or more frame content IDs stored on the storage device. If there is a matching frame content ID, update that frame content ID with the associated content stored in the storage device 706.

FIG. 7b illustrates the process flow of a method of this invention for downloading content for the one or more frame content IDs of a DDD by connecting to a DDD server. This downloading process may be initiated by using a schedule that was programmed on the DDD at the DDD manufacturer. The downloading process can also be initiated by a schedule inputted to the DDD by the DDD viewer or the DDD content provider, a manual update selected by the DDD viewer or the DDD content provider, or other event that may trigger the downloading process.

After the updating process has been initialized, the DDD connects to a DDD server 720 by using the DDD serial number or the frame content ID(s) 722 stored on the DDD. The DDD can connect to the DDD server through a variety of ways, including a direct connection to the DDD server, an internet connection via a dial-up connection, a broadband connection, a Wi-Fi connection, a satellite connection, and other types of connections. In other embodiments of the methods of this invention, a DDD may log in to the DDD server using a variety of indicators, including the DDD's serial number, a frame content ID, the associated nickname for the frame content ID, or other information to identify the DDD.

The DDD server can use the log in information provided by the DDD and search for the frame content IDs associated with the DDD 724. As stated above, one way to find all the associated frame contend IDs is to have a table of all the unique identifiers of all DDDs, and placing the associated frame content IDs with the unique identifier in one database, such that looking up a unique identifier will return the frame content IDs. The frame content IDs may be cross referenced on another database, where that database lists the associated frame content IDs with the associated DDD content providers.

Next determine whether the DDD has one or more of the associated frame content IDs 726. If the DDD does not have an associated frame content ID, then the update process ends since there is no content to download. If the DDD has one or more associated frame content IDs, then determine whether the content is already stored on the DDD. If the content is already stored on the DDD, then the upload process ends since the DDD already has the content stored.

If the content is not stored on the DDD, then proceed with downloading the content. The DDD determines whether the DDD viewer wants to define a display setting for the content 728. The display setting may include selecting one or more frame content IDs for display 750, editing the content of the one or more selected frame content IDs 752, selecting a display order for the content of the one or more selected frame content IDs 754, and selecting a duration of time to display the content of the one or more selected frame content IDs 756.

The DDD viewer can define a display setting 730 by inputting his/her preferences to the DDD or storing his/her preferences on the DDD server. FIG. 7c illustrates a process flow of a method for defining a display setting for a DDD. The DDD viewer may first select one or more frame content IDs for display 750. For instance, the DDD viewer may want to change the content of their DDDs from displaying the frame content ID containing only their son's photos, to displaying the frame content ID containing only their daughter's photos. And when the DDD viewer wants to change back, that frame content ID will still be stored on the DDD server such that they can easily switch back. If the DDD viewer does not select one or more of the frame content IDs, then the methods of this invention will select all available frame content IDs for display on the DDD.

The DDD viewer can select content of the one or more selected frame content IDs 752 to display on the DDD. The DDD viewer may first pick one of the one or more selected frame content IDS. Then, for that one frame content ID, define which content of the frame content ID the DDD viewer wants to display or not display. For instance, if grandma has multiple frame content IDs for her DDD, and each associated frame content ID contains weather information, grandma may choose to select only one for display instead of displaying the weather information multiple times. Furthermore, if grandma does not want to read any news articles on the DDD, she can select all the news articles for non-display. If no content is selected or the DDD viewer selects all content to view, then all the content of the selected frame content IDs will be downloaded for display.

The DDD viewer may next select a display order for the content of the one or more selected frame content IDs 754. Following the example above, if grandma, the DDD viewer, wants to group all the content containing her grandchildren images first, then possibly grouping all the video content together, and finally possibly grouping the news content together. Additionally, the grandma can select an option to randomly select content across one or more of the frame content IDs for display. Likewise, grandma can choose to set the display order to display defined content, and then randomly pick the display order of the rest of the non-selected items.

The DDD viewer may next select the duration of time to display the content of the one or more selected frame content IDs 756. The DDD viewer may manually input the duration of time to display the content of the one or more frame content IDs. The DDD viewer can also select an automatically defined setting to select the duration of time to display the content based on the type of content, priority of the content, the DDD content provider who selected the content, the size of the content, and other factors. The type of content may be defined to include a photo, video, news item, weather information, stock lists, or other types of selected content. The priority of the content may be based on several factors including, the type of the content, the DDD content provider who selected the content, and if the content is duplicated in an associated frame content ID of the DDD. Priority may also be assigned and overwritten by the DDD viewer or the DDD content provider associated with that frame content ID. For instance, grandma may want to display the news items longer than photos since it generally takes longer to read the news than to view pictures. Furthermore, if the grandson wants to emphasize a particular content, he may assign that content a very high priority, such that the duration of time to display the content is increased relative to the other content. Grandma can always overwrite that priority with her own defined priorities.

If the DDD viewer does not want to define a display setting, then the DDD may automatically define a display setting for the DDD 728. The DDD may determine whether any of the frame content IDs are from DDD content providers that have been denied access by the DDD viewer. For instance if mom does not want to see pictures from her ex-husband's user account, then she may block all content from his account. Without any specific access denials, the DDD will allow content from all the frame content IDs associated with the DDD. Similarly all the content will be allowed unless the DDD viewer has defined which type of content to deny. As for a display order the DDD may select a display order based on the type of the content, the priority of the content, which user selected the content, the size of the content, past user selected content, whether the content is ready for download, and other factors.

The DDD may also define the duration of time to display as a function of type of content, priority of the content, which user selected the content, the size of the content, past viewer-selected content, and other factors.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for defining content for display on a digital display device (“DDD”), comprising the steps of:
defining content for the DDD by a first DDD content provider at a point of purchase;
associating a frame content ID with the defined content; and
programming the DDD with the frame content ID prior to shipping of the DDD.

2. A method of claim 1 further comprising the step of setting up a user account to manage content for the DDD.

3. A method of claim 1 further comprising the step of selecting one or more options of the DDD.

4. A method of claim 3 wherein in the defining step, said content is a function of the one or more selected options of the DDD.

5. A method of claim 1 further comprising of the step of downloading said defined content to the DDD prior to shipping of the DDD.

6. A method of claim 1 further comprising the step of shipping the DDD to a DDD viewer, wherein the point of purchase is at a first location and the DDD is shipped to a second location.

7. A method of claim 6 further comprising the step of updating content for the DDD by downloading data from a DDD server.

8. A method of claim 6 further comprising the step of defining a display setting for the DDD.

9. A method of claim 1 further comprising the step of updating content for the DDD by the DDD logging on to a DDD server by downloading data from a DDD server.

10. A method of claim 1 further comprising the step of defining a display setting for the DDD.

11. A method for defining content for display on a DDD, comprising the steps of:
setting up a user account to manage content for the DDD;
defining content for the DDD by a first DDD content provider at a point of purchase;
associating a frame content ID with the defined content; and
programming the DDD with the frame content ID prior to shipping of the DDD.

12. A method of claim 11 further comprising the step of selecting one or more options of the DDD.

13. A method of claim 12 wherein in the defining step, said content is a function of the one or more selected options of the DDD.

14. A method of claim 11 further comprising of the step of downloading said defined content to the DDD prior to shipping of the DDD.

15. A method of claim 14 further comprising the step of shipping the DDD to a DDD viewer, wherein the point of purchase is at a first location and the DDD is shipped to a second location.

16. A method of claim 14 further comprising the step of updating content for the DDD by the DDD logging on to a DDD server by downloading data from a DDD server.

17. A method of claim 11 further comprising the step of updating content for the DDD by the DDD logging on to a DDD server by downloading data from a DDD server.

18. A method of claim 11 further comprising the step of defining a display setting for the DDD.

19. A method of claim 15 further comprising the step of defining a display setting for the DDD.

20. A method for defining content for display on a DDD, comprising the steps of:
setting up a user account to manage content for the DDD;
selecting one or more options of the DDD;
defining content for the DDD by a first DDD content provider at a point of purchase, wherein said content is a function of the one or more selected options of the DDD;
associating a frame content ID with the defined content;
programming the DDD with the frame content ID prior to shipping of the DDD;
downloading said defined content to the DDD prior to shipping of the DDD;
shipping the DDD to a DDD viewer, wherein the point of purchase is at a first location and the DDD is shipped to a second location;
updating content for the DDD by the DDD logging on to a DDD server; and
defining a display setting for the DDD.
